(19) United States
(12) Patent Application Publication
(10) Pub. No.: US 2003/0100327 A1
(43) Pub. Date: May 29, 2003

(54) Method of establishing a wireless telecommunications connection

(75) Inventors: Stephen Kaminski, Eislingen (DE); Hajo Bakker, Eberdingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/299,693

(22) Filed: Nov. 20, 2002

(30) Foreign Application Priority Data
Nov. 27, 2001 (DE) 101 57 940.3

(51) Int. Cl. H04B 1/38

(52) U.S. Cl. 455/517; 455/560

(57) ABSTRACT

In a method for establishing a telecommunications (=TC) connection between a first and a second terminal (12, 13) of a wireless telecommunications (TC) network (11), of which at least one is connected to a third terminal (14) via a control connection (16-18), the establishment of a direct TC connection (19) between the first and second terminal (12, 13) is initiated by the third terminal (14). This measure facilitates a higher data throughput in the network (11).

### BACKGROUND OF THE INVENTION

The invention relates to a method of establishing a telecommunications (TC) connection between a first and a second terminal of a wireless telecommunications (TC) network, of which at least one is connected to a third terminal via a control connection. The invention is based on a priority application DE 101 57 940.3 which is hereby incorporated by reference.

### SUMMARY OF THE INVENTION

In the prior art it is known, in a wireless TC network, for example according to the HiperLAN/2 standard, to operate two mobile terminals, such as for example portable computers (laptops), with only one input device which can have the form of a mobile input device, such as for example a mouse. Both terminals maintain a connection to the input device. If an object is to be copied from the one terminal to the other terminal, the corresponding data are firstly copied to the input device and stored therein. Then the data are transmitted from the input device to the other terminal. As a result of this procedure the copying of data from one terminal to another terminal is relatively slow. The establishment of the TC connection is initiated by one of the terminals.

Therefore the object of the present invention is to develop a method of improving the copying of data from a first terminal to a second terminal.

This object is achieved, in accordance with the invention, by a method of the type referred to in the introduction, wherein the establishment of a direct TC connection between the first terminal and the second terminal is initiated by the third terminal.

In contrast to the prior art, the data need not firstly be transmitted to the third terminal, which can have the form of an input device, for example a mouse, and from there in turn to the second terminal, but rather the data can be directly exchanged between the first terminal and the second terminal. Therefore it is only necessary to exchange control commands between the terminals (first and second) and the third terminal. The terminals, which can be mobile devices, can form part of a wireless TC network. In accordance with the invention, a wireless TC network is to be understood as a network in which the data exchange between the individual devices takes place not via cable, but via radio or infrared or another suitable cordless transmission. The method according to the invention facilitates a larger data throughput in such a network as the data to be copied or exchanged need not be transmitted twice, but only once. Moreover, the copying process is distinctly faster with the method according to the invention.

In a preferred method variant, the third terminal transmits a connection identifier to the first terminal and second terminal via the respective control connection. The connection identifier can be known to the third terminal or can be requested by the latter from another location of the TC network. The connection between the first terminal and second terminal is initiated by the transmission of the connection identifier. This means that the terminal from which data are to be copied can directly address the other terminal. It is particularly advantageous that the connection identifier can be transmitted to the first terminal and second terminal via the control connections which are anyhow present. The method assumes that the terminals are logged into a TC network and thus are known, so that a direct TC connection can be established between the first terminal and the second terminal, both of which are logged in.

In a method variant, the first terminal and second terminal communicate with the third terminal via an access point. This means that a connection exists between each terminal and the access point. A control connection is then in each case composed of the connection between the third terminal and the access point, and of the connection between the access point and the respective other terminal (first or second terminal). Alternatively it can be provided that from the third terminal a direct control connection in each case exists to the first terminal and second terminal. The control connections are coordinated by the access point. A terminal can log into the TC network via an access point. The access point can control the data communication in the TC network or in parts thereof. It can thus be provided that the third terminal requests from the access point the connection identifier for a direct TC connection between two other terminals. This means that the access point assigns the connection identifier to a direct TC connection to be established.

In a preferred further development of the method, the access point establishes the direct TC connection. In this case the establishment of the direct TC connection between the first terminal and second terminal is initiated by the third terminal, whereas the actual establishment of the TC connection is performed by the access point. If an access point is used, it is also conceivable for the access point only to establish a logical connection between the first terminal and second terminal and for the objects or corresponding data to be transmitted via a physical connection firstly to the access point and from there to the respective other terminal. Also in this case however, there is no transmission of the data to the third terminal. Alternatively it can be provided that the first or second terminal establishes the direct TC connection.

The scope of the invention also includes a wireless TC network with at least one first terminal and second terminal and with at least one third terminal which is connected to the first terminal and second terminal via control connections, for the execution of the method according to the invention. In a TC network of this kind, data can be copied or transferred from a first terminal to a second terminal more rapidly and with a lower load on the TC network. In particular, cut and paste processes can be performed more rapidly and easily.

If the TC network is an ad hoc network, the TC network does not possess a predetermined infrastructure and additional terminals can log in. A TC network of this kind is extremely flexible. Direct connections between terminals already present in the TC network and recently logged into the TC network can also be initiated by means of the third terminal.

In an advantageous embodiment of the network, one of the terminals is an access point. As a result of this measure, the control of the data communication in the TC network takes place from a terminal and it is unnecessary to provide a separate access point.

In an alternative embodiment of the network, one of the terminals is simultaneously a master terminal which controls the data communication in the TC network.

The scope of the invention also includes a terminal for the execution of the method according to the invention. With a terminal of this kind, data can be directly transmitted to another terminal, the direct wireless connection being initiated by a third terminal, in particular an input device.

The scope of the invention also includes an access point for the execution of the method according to the invention. In particular, the connection identifier for the direct wireless connection can be requested from an access point and the direct wireless connection can be established by the access point.

### BRIEF DESCRIPTION OF THE DRAWINGS

Further advantages of the invention will become apparent from the description and from the drawing. The features referred to the foregoing and those to be referred to in the following can be used, in accordance with the invention, individually or jointly in any combinations. The illustrated and described embodiments should not be considered as definitive, but rather are of an exemplary nature for the description of the invention.

The invention is schematically illustrated in the drawing and will be explained in detail making reference to an exemplary embodiment. In the drawing:

FIG. 1 illustrates a wireless, ad hoc network with no access point and

FIG. 2 illustrates a wireless network with access point.

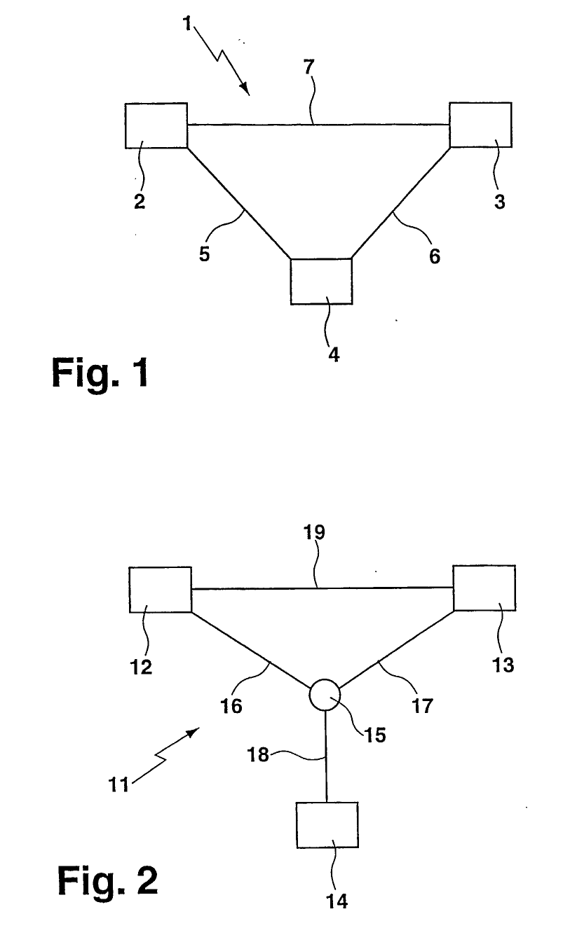

A wireless TC network 1 is schematically illustrated in FIG. 1. The TC network 1 comprises a first and a second terminal 2, 3, in each case in the form of a mobile computer (laptop). The first and second terminal 2, 3 are operated by means of a third terminal 4 in the form of a mouse. For this purpose a wireless control connection 5, 6, i.e. a radio connection, exists between each terminal 2, 3 and the third terminal 4. The first and second terminal 2, 3 and the third terminal 4 are logged into the TC network 1. If objects are to be transmitted from the first terminal 2 to the second terminal 3, in particular if data displayed on a display unit of the first terminal 2 are to be transmitted to the display unit of the second terminal 3, for example by cut/copy and paste functions or so-called drag and drop functions, the third terminal 4 initiates the establishment of a direct TC connection 7 between the first and second terminal 2, 3, via which the objects or corresponding data can be transmitted. For this purpose, the third terminal 4 sends a connection identifier to the first and second terminal 2, 3, so that for example the first terminal 2 can directly address the second terminal 3 and can establish the direct TC connection 7. In the example the first terminal 2 has the form of a master terminal which performs the connection establishment.

FIG. 2 illustrates a TC network 11 comprising a first and a second terminal 12, 13 each in the form of a mobile computer (laptop). The first and second terminal 12, 13 are operated by means of a third terminal 14 in the form of a mouse. The third terminal 14 communicates with an access point 15 which in turn is connected to the first and second terminal 12, 13. The first terminal 12 is thus connected to the third terminal 14 via the control connection 16, 18, and the second terminal 13 is connected thereto via the control connection 17, 18. The access point 15 manages and controls the communication and data exchange in the TC network 11. If objects are to be transmitted from the first terminal 12 to the second terminal 13 by means of the third terminal 14, the third terminal 14 initiates a direct TC connection 19 between the first and second terminal 12, 13 in that it requests a connection identifier from the access point 15 and communicates this connection identifier to the first terminal and second terminal 12, 13. The access point 15 then establishes the direct TC connection 19.

1. A method of establishing a telecommunications connection between a first and a second terminal of a wireless telecommunications network, of which at least one is connected to a third terminal via a control connection, wherein the establishment of a direct TC connection between the first and second terminal is initiated by the third terminal.

2. A method according to claim 1, wherein the third terminal transmits a connection identifier to the first and second terminal via the respective control connection.

3. A method according to claim 1, wherein the first and second terminal communicate with the third terminal via an access point.

4. A method according to claim 3, wherein the access point establishes the direct TC connection.

5. A method according to claim 1, wherein the first or second terminal establishes the direct TC connection.

6. A wireless TC network with at least one first and second terminal and at least one third terminal which is connected to the first and second terminal via control connections, for the execution of a method of establishing a telecommunications connection between a first and a second terminal of a wireless telecommunications network, of which at least one is connected to a third terminal via a control connection, wherein the establishment of a direct TC connection between the first and second terminal is initiated by the third terminal.

7. A TC network according to claim 6, wherein the TC network is an ad hoc network.

8. A TC network according to claim 6, wherein one of the terminals is an access point.

9. A TC network according to claim 6, wherein one of the terminals is simultaneously a master terminal which controls the data communication in the TC network.

10. A terminal for the execution of a method of establishing a telecommunications connection between a first and a second terminal of a wireless telecommunications network, of which at least one is connected to a third terminal via a control connection, wherein the establishment of a direct TC connection between the first and second terminal is initiated by the third terminal.

11. An access point for the execution of a method of establishing a telecommunications connection between a first and a second terminal of a wireless telecommunications network, of which at least one is connected to a third terminal via a control connection, wherein the establishment of a direct TC connection between the first and second terminal is initiated by the third terminal.
